(19) United States
(12) Patent Application Publication
(10) Pub. No.: US 2013/0258513 A1
(43) Pub. Date: Oct. 3, 2013

(54) MAGNETIC READ-WRITE INSPECTION APPARATUS AND MAGNETIC READ-WRITE INSPECTION METHOD

(71) Applicant: HITACHI HIGH-TECHNOLOGIES CORPORATION, Tokyo (JP)

(72) Inventors: Yoshihiro SAKURAI, Kamisato-machi (JP); Toshiaki SUZUKI, Kamisato-machi (JP); Kazuhiko KISHIE, Kamisato-machi (JP)

(73) Assignee: HITACHI HIGH-TECHNOLOGIES CORPORATION, Tokyo (JP)

(21) Appl. No.: 13/756,565

(22) Filed: Feb. 1, 2013

(30) Foreign Application Priority Data
Mar. 29, 2012 (JP) 2012-077601

(51) Int. Cl. G11B 20/18

(52) U.S. Cl. CPC G11B 20/182
USPC 360/31

(57) ABSTRACT

Provided are magnetic read-write inspection apparatus and inspection method allowing measurement and inspection again by a sector servo system even when a magnetic disk measured and inspected by the sector servo system is detached from the inspection apparatus and re-mounted. A data write unit writes a servo pattern signal in a predetermined track range of the disk, writes an inspection test pattern signal onto an inspection track by performing sector-servo-system-based positioning and concentrically writes an eccentricity learning pattern onto an eccentricity learning track which is different from the inspection track. An eccentric quantity learning unit calculates an eccentric quantity of the disk from a read signal detection position by reading out the eccentricity learning pattern without using servo information. An eccentric quantity correction unit controls shaking of a magnetic head so as to cancel the calculated eccentric quantity when reading out a test signal from the disk.

### CLAIM OF PRIORITY

The present application claims priority from Japanese patent application serial No. JP 2012-077601, filed on Mar. 29, 2012, the content of which is hereby incorporated by reference into this application.

### BACKGROUND OF THE INVENTION

(1) Field of the Invention

The present invention relates to magnetic read-write inspection apparatus and magnetic read-write inspection method, and more particularly to a technique of favorably correcting eccentricity occurring when a magnetic disk is mounted.

(2) Description of the Related Art

In a magnetic read-write inspection apparatus that inspects performances of a magnetic disk and a magnetic head to be loaded on a hard disk drive (HDD), the performances of the magnetic disk and the magnetic head are inspected by positioning the magnetic head on a predetermined track in accordance with servo information written on the disk, writing data for inspection to the magnetic disk and then reading out the written data from the magnetic disk. In the above mentioned case, a sector servo system that servo information is provided per sector in a partial region of a data track is adopted in order to cope with recent increases in track density and recording density so as to further increase track-following accuracy.

In Japanese Patent Application Laid-Open Publication No. 2003-272326, there is described a configuration that a piezoelectric actuator is installed between a suspension spring and a head carriage in order to speedily, accurately and dynamically position a magnetic head substantially on the center of a track in relation to the above mentioned technique. Then, it is configured such that when the head is positioned on a predetermined track so as to gain access to this track, a head cartridge which is light in mass is dynamically moved in accordance with servo information or a head assembly is dynamically moved within the head cartridge in accordance with the servo information by the piezoelectric actuator so as to make the piezoelectric actuator perform an operation of holding the head in an ON-track state.

In addition, in general, a feedforward control system is used as an effective system of compensating for eccentricity of a disk (see, for example, Published Japanese Translation of PCT Application No. JP2002-544639, Japanese Patent Application Laid-Open Publication No. Hei6-84306 and Japanese Patent Application Laid-Open Publication No. 2011-141925). In the above mentioned system, an eccentricity compensation signal which is stored in a memory is added to a control signal as a feedforward signal to correct the eccentricity of the disk.

### SUMMARY OF THE INVENTION

For example, inspection of thermal demagnetization characteristics is given as one of inspection items of a magnetic disk. In this inspection, test data (a test pattern) is written on/read out from the magnetic disk concerned at a steady temperature, then the test pattern is again read out after leaving the disk in a constant temperature tank at a high temperature for a long period of time, and thereafter the disk is inspected for heat deterioration (thermal demagnetization characteristics) which would occur in the disk performance from a change in read value. In this inspection, it is unavoidable to evaluate many disks in consideration of a disk-by-disk variation in characteristics. In the above mentioned case, since an inspection system that an inspection apparatus is contained in the constant temperature tank takes much time to evaluate one disk, working efficiency thereof is low and hence it is not suited for evaluation of many disks. An inspection system that many disks on/from which a test pattern has been written/read out at the steady temperature are stocked and then are left in the constant temperature tank at one time is desirable in order to increase the working efficiency. In the above mentioned case, it is desirable that inspection be allowed with no breakdown of the sector servo system even when the disk is temporarily detached from the inspection apparatus and then is again mounted on it.

It may be said that the technique disclosed in Japanese Patent Application Laid-Open Publication No. 2003-272326 is a system which is effective to compensate for a displacement of not more than several Hz (about several μm) due to thermal drift or the like occurring in a state that the magnetic disk is fixed on a spindle. However, it is difficult to perform sufficient tracking control on a displacement of at least several Hz, for example, several μm of a frequency component (90 to 250 Hz) in disk eccentricity by this system.

When the disk has been temporarily detached and then mounted again, an eccentric quantity of several tens μm is generated due to an error in centering accuracy and a fit tolerance of the disk bore. Even if marks used for alignment when mounting again the disk are put on a spindle hub and the disk in advance and then the disk is fixed by putting it aside in a specific direction when mounting the disk in order to reduce the eccentricity, an eccentric quantity of about several μm will be left uncancelled. Therefore, it is expected that tracking will become difficult simply by feedback-control-based driving performed by the piezoelectric actuator described in Japanese Patent Application Laid-Open Publication No. 2003-272326. This means that application of the above mentioned sector servo system becomes difficult.

The present invention aims to provide a magnetic read-write inspection apparatus that allows measurement and inspection of a magnetic disk again by the sector servo system even when this magnetic disk which has been measured and inspected once by the sector servo system is detached from the inspection apparatus and is again mounted on it and a magnetic read-write inspection method used in the apparatus.

A magnetic read-write inspection apparatus according to the present invention includes a data writing unit writing the servo information and the test signal to a predetermined inspecting track of the magnetic disk and concentrically writing an eccentricity learning pattern to an eccentricity learning track which is different from the inspecting track using the magnetic head, a data reading unit reading out the test signal from the inspecting track of the magnetic disk in accordance with the servo information and reading out the eccentricity learning pattern from the eccentricity learning track using the magnetic head, an eccentric quantity learning unit calculating an eccentric quantity of the magnetic disk from a detecting position of a read signal by reading out the eccentricity learning pattern without using the servo information and an eccentric quantity correcting unit controlling shaking of the magnetic head so as to cancel out the calculated eccentric quantity when reading out the test signal from the magnetic disk.

In the magnetic read-write inspection apparatus, the eccentric quantity learning unit reads out the eccentricity learning pattern while moving the magnetic head in a radius direction of the disk using a radius position of the eccentricity learning track as a reference and calculates the eccentric quantity of the magnetic disk from a relation between a moving amount and the detecting position of the read signal.

A magnetic read-write inspection method according to the present invention includes the steps of writing the servo information and the test signal to a predetermined inspecting track of the magnetic disk using the magnetic head, concentrically writing an eccentricity learning pattern to an eccentricity learning track which is different from the inspecting track using the magnetic head, reading out the eccentricity learning pattern without using the servo information from the eccentricity learning track of the magnetic disk using the magnetic head, calculating an eccentric quantity of the magnetic disk from a detecting position of a read signal for the eccentricity learning pattern and reading out the test signal from the inspecting track of the magnetic disk in accordance with the servo information while controlling shaking of the magnetic head so as to cancel out the calculated eccentric quantity. According to the present invention, since it is allowed to correct the eccentric quantity generated when mounting again the magnetic disk, highly accurate and highly efficient inspection is allowed by applying the sector servo system.

### BRIEF DESCRIPTION OF THE DRAWINGS

These and other features, objects and advantages of the present invention will become more apparent from the following description when taken in conjunction with the accompanying drawings wherein:

FIG. 1 is a block configuration diagram illustrating an example of a magnetic read-write inspection apparatus according to one embodiment.

FIG. 2 is a detailed diagram illustrating an example of an ON-track servo circuit 11 and a data process/control circuit 20.

FIG. 3 is a diagram illustrating an example of a test pattern and an eccentricity learning pattern to be written onto a disk.

FIG. 4 is a diagram illustrating an example of a trace of the magnetic disk when the disk is eccentric and a reproduction signal thereof.

FIG. 5 is a diagram illustrating an example of changing of cross points when a radial position for reading has been moved.

FIG. 6 is a diagram illustrating an example of a relation between an eccentric quantity and a phase angle of the disk obtained from measurement in FIG. 5.

FIG. 7 is a flowchart illustrating an example of an inspection method performed by the magnetic read-write inspection apparatus.

### DETAILED DESCRIPTION OF THE EMBODIMENTS

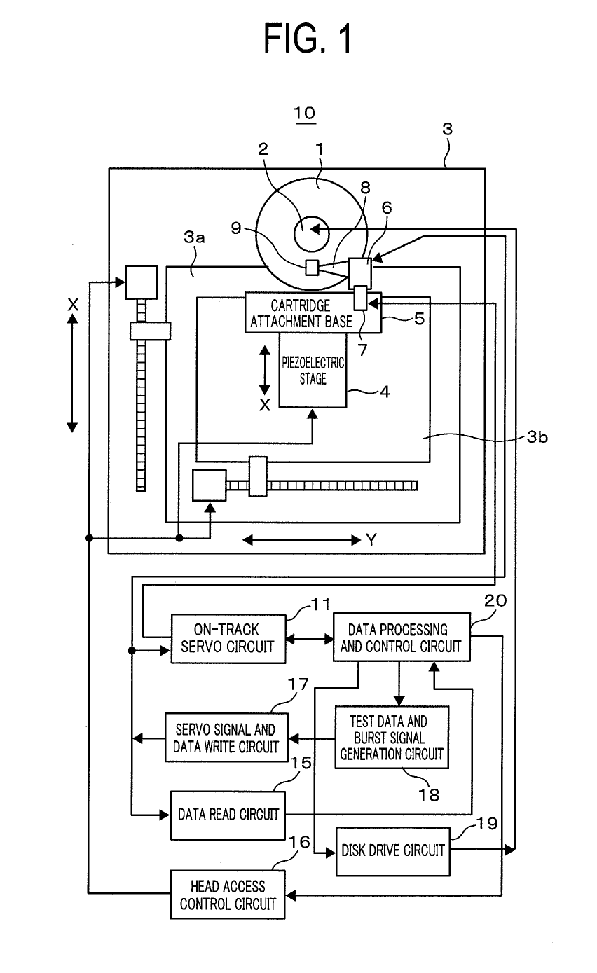

Hereinafter, embodiments of the present invention will be described with reference to the accompanying drawings. FIG. 1 is a block configuration diagram illustrating an example of a magnetic read-write inspection apparatus according to an embodiment of the present invention. In a magnetic read-write inspection apparatus (also simply referred to as an inspection apparatus), a magnetic disk (simply referred to as a disk) 1 which is to be inspected is detachably mounted on a spindle 2. A magnetic head (simply referred to as a head) 9 is loaded on a leading end of a suspension spring 8 to perform data writing (recording) and data reading (reproduction) on the disk 1. Mechanisms as follows are included in order to make the head 8 movable relative to the disk 1 in a radius direction (an X direction) and a circumference direction (a Y direction).

An XY stage 3 is disposed adjacent to the spindle 2 as a head carriage. An X stage 3a and a Y stage 3b are loaded on the XY stage 3. The X stage 3a is a coarse motion stage and moves the Y stage 3b together with the head 9 and a piezoelectric stage 4 in the radius direction (the X direction) of the disk 1. The Y stage 3b is loaded on the X stage 3a and performs skew adjustment on the head 9 by moving in the circumference direction (the Y direction) of the disk 1. The piezoelectric stage 4 which is loaded on the Y stage 3b is a stage for micro-motion in the X direction and a cartridge installation base 5 is coupled to the leading end side of the piezoelectric stage 4. A head cartridge 6 is loaded on the cartridge installation base 5 via a piezoelectric actuator 7. The suspension spring 8 is fixed to the head cartridge 6 and the head 9 is loaded on the leading end side of the suspension spring 8. The head cartridge 6 is adapted to detachably mount the head 9 on the head carriage. The cartridge installation base 5 moves in the X direction by driving the piezoelectric stage 4 in the X direction to induce micro-motion of the position of the head 9 in the X direction via the cartridge 6. Incidentally, the X direction matches the direction of a radius R passing through the center of the disk 1.

The piezoelectric stage 4 is driven as the micro-motion stage used when data (a later described eccentricity learning pattern) is written onto/read out from the disk 1. The stroke of the piezoelectric stage 4 is, for example, about 15 μm and a distance resolution attained in the above mentioned case is about 1 nm. The head 9 moves in the radius direction of the disk 1, seeks a target track of the disk 1 and is positioned on the target track. Then, the head 9 performs a so-called access operation that data is written to the target track or is read out from the target track.

On the other hand, the piezoelectric actuator 7 is allowed to drive the head cartridge 6 forward and backward in the X direction at a high speed. When the head 9 gains access to a certain track (or a specific region in the track), the piezoelectric actuator 7 reads out a servo signal on the track and finely adjusts the position of the head in accordance with the read servo signal, thereby dynamically making the head 9 follow the target track. Hereinafter, this operation will be called ON-track servo positioning. In addition, the piezoelectric actuator 7 also performs an operation of shaking the head 9 for correction of an eccentric quantity of the disk as described later. A distance over which the piezoelectric actuator 7 moves back and forth for fine adjustment as mentioned above is very short and on the order of 10 μm or in a range which is lower than the above.

Although the piezoelectric actuator 7 is installed on the outer side of the head cartridge 6 in the example in FIG. 1, the head cartridge 6 may be built in the head cartridge 6 alternatively. In the latter case, the piezoelectric actuator 7 will be installed in front of the suspension spring 8 to support the suspension spring 8 to freely revolve or move back and forth.

Next, a signal process system and a control system will be described. The data process/control circuit 20 rotates the spindle 2 with the disk mounted via a disk drive circuit 19. A head access control circuit 16 receives a control signal from the data process/control circuit 20 and drives the X and Y stages 3a and 3b and the piezoelectric stage 4 to position the head 9 on the target track on the disk 9.

A data read circuit 15 binarizes a read signal from the head 9 and sends the binarized signal to the data process/control circuit 20. In addition, the data read circuit 15 sends a detection signal for the eccentricity learning pattern read out from the disk 9 to the data process/control circuit 20. The data process/control circuit 20 learns the eccentric quantity when the disk is mounted from the position of the eccentricity learning pattern detection signal and stores the learned eccentric quantity.

A test data/burst signal generation circuit 18 is controlled by the data process/control circuit 20 to generate predetermined test data and burst signal, and also later described eccentricity learning data. A servo signal/data write circuit 17 generates a write signal (a signal pattern) in accordance with the generated test data, burst signal and eccentricity learning data and writes data to a predetermined track from the head 9.

The ON-track servo circuit 11 receives a read signal from the head 9, applies a fine drive voltage to the piezoelectric actuator 7 in accordance with the read-out servo signal to perform ON-track servo positioning. In the ON-track servo positioning, many servo signals which are set on a positioning track at predetermined intervals are sequentially read to correct an amount of deviation of the head (an amount of deviation of the head from the track center) on the positioning track in accordance with the servo signals. Thus, it is allowed to make the head 9 follow the target track in response to the displacement due to thermal drift or the like. In addition, the ON-track servo circuit 11 makes the head 9 follow the target track while cancelling the eccentric quantity generated when mounting the disk by adding the disk eccentric quantity learned by the data process/control circuit 20 to a servo positioning signal as an offset.

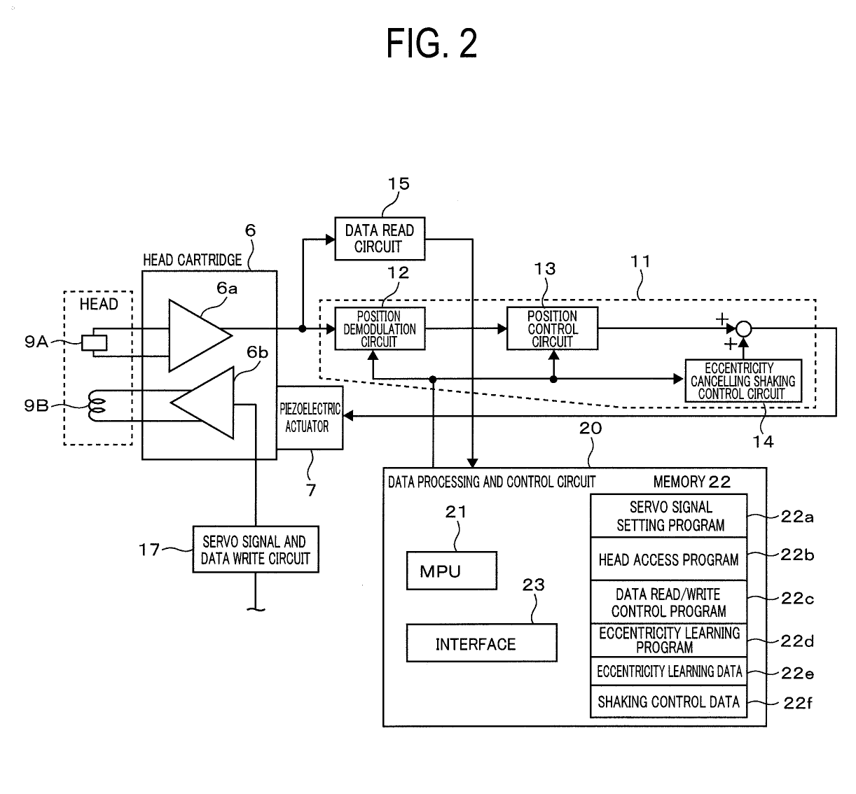

FIG. 2 is a detailed diagram illustrating an example of the ON-track servo circuit 11 and the data process/control circuit 20 illustrated in FIG. 1.

The magnetic head 9 includes an MR head 9A used for reading and an inductive head 9B used for writing, and a read amplifier 6a and a write amplifier 6b are built in the head cartridge 6. The read amplifier 6a receives a signal from the MR head 9A, amplifies the received signal and outputs the amplified signal to the ON-track servo circuit 11 and the data read circuit 15.

The ON-track servo circuit 11 includes a position demodulation circuit 12, a position control circuit 13 and an eccentricity cancelling shaking control circuit 14, and these circuits are controlled by the data process/control circuit 20.

The position demodulation circuit 12 receives a read signal (a servo signal) from the read amplifier 6a and sends an error signal (an amount of positional deviation from the center of a data track) to the position control circuit 13. The position control circuit 13 generates a drive signal for returning the position of the head 9 to the center of the data track in accordance with the error signal and outputs the drive signal to the eccentricity cancelling shaking control circuit 14.

The eccentricity cancelling shaking control circuit 14 adds a shaking control signal which is sent from the data process/control circuit 20 in order to cancel the eccentricity of the disk to the drive signal sent from the position control circuit 13. The drive signal with the shaking control signal added is applied to the piezoelectric actuator 7. Thus, it is allowed to hold the head 9 in the ON-track state while correcting the position of the head 9 so as to cancel the eccentricity regardless of presence of the eccentricity when mounting the disk and inspection to which the sector servo system is applied is allowed.

The data process/control circuit 20 includes a microprocessor (MPU) 21, a memory 22, an interface 23, and not illustrated display, keyboard and others and these elements are connected with one another via a bus.

A servo signal setting program 22a that specifies procedures of the inspection, a head access program 22b, a data read/write control program 22c, and an eccentricity learning program 22d, eccentricity learning data 22e, shaking control data 22f and others used to learn and control the eccentricity of the disk 1 are stored in the memory 22 and these programs and data are executed (written/read out) by the MPU 21.

The servo signal setting program 22a is used to control writing/reading of the servo signal incidental to the test data. The head access program 22b is used to receive a track crossing signal (or a track position signal) from the head 9 and to control the X and Y stages 3a and 3b, and the piezoelectric stage 4 via the head access control circuit 16 in accordance with reception of the signal, thereby positioning the head 9 on the target track. The data read/write control program 22c is used to control a test data reading or writing operation.

The eccentricity learning program 22d is used to perform a series of controlling operations for learning the eccentricity of the mounted disk 1. The eccentricity learning data 22e is used to store data (the eccentricity learning pattern) to be written onto the disk for learning the eccentricity and to save eccentricity data on the disk 1 acquired when learning the eccentricity. The shaking control data 22f is data on a signal (a drive voltage) which is calculated on the basis of the learned eccentricity data and is applied to the piezoelectric actuator 7 for cancellation of the disk eccentricity.

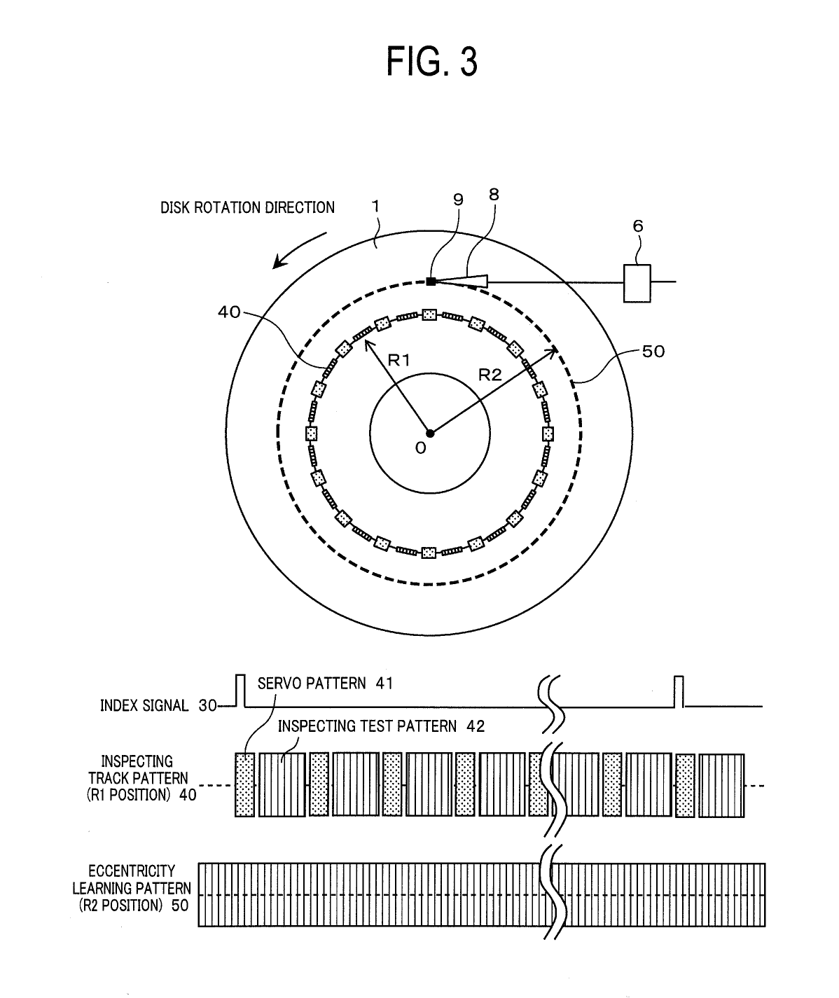

In the following, an eccentricity learning method according to an embodiment of the present invention will be described in detail. FIG. 3 is a diagram illustrating an example of the test pattern and the eccentricity learning pattern to be written on the disk concerned. In the drawing, a recording track formed on the disk 1 is schematically illustrated on its upper part and recording signals (patterns) are schematically illustrated on its lower part.

An index signal 30 indicating a reference position in a direction in which the disk 1 is rotated is given to the disk 1 to divide the recording region of the disk 1 into a plurality of sectors (for example, 1024 sectors) circumferentially. The piezoelectric stage 4 is driven to record positioning servo patterns 41 one by one per sector at a defined track pitch (for example, a pitch corresponding to one-third of a head core width) in respective desirable minimum track ranges (for example, around 1 μm) before and behind each range for inspection test pattern on an inspection track of a radius R1. Next, the magnetic head 9 is positioned on the inspection track of the radius R1 using the servo pattern 41 by the sector servo system to record inspection test patterns 42 one by one per sector. Hereinafter, the servo pattern 41 and the inspection test pattern 42 will be generally referred to as an inspection track pattern 40.

Next, the magnetic head 9 is positioned on a track of a radius R2 which is different from the inspection track (the radius R1) to concentrically record an eccentricity learning pattern 50 (on an eccentricity learning track). Here, the eccentricity learning track (the radius R2) and the inspection track (the radius R1) are formed apart from each other with a space of a value which is sufficiently larger than an expected value of the disk eccentric quantity left between them. Alternatively, the eccentricity learning track (the radius R2) may be arranged on the inner side of the inspection track (the radius R1). Although the frequency of the eccentricity learning pattern 50 may be arbitrarily set, it is supposed to be, for example, 10 MHz that allows sufficient detection of a signal level upon reproduction.

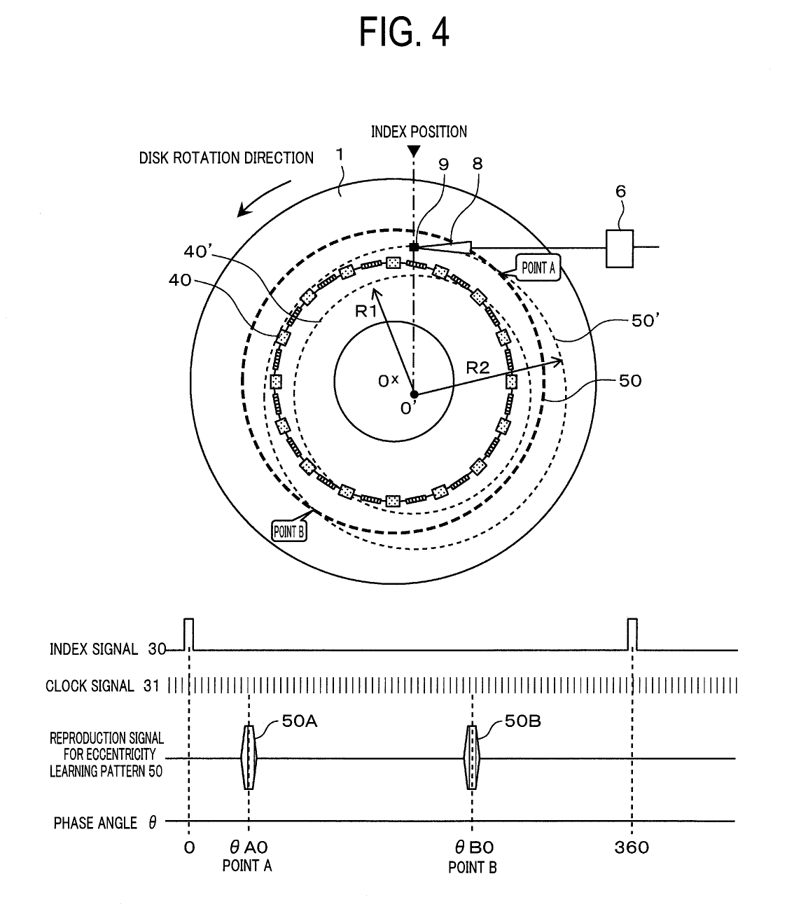

FIG. 4 is a diagram illustrating an example of a trace of the magnetic head 9 when the disk 1 is eccentric and a reproduction signal obtained in the above mentioned situation. FIG. 4 illustrates a case that the center of rotation obtained when the inspection track pattern 40 (the servo pattern 41 and the inspection test pattern 42) and the eccentricity learning pattern 50 have been recorded on the disk 1 is designated by 0, eccentricity has occurred when mounting again the disk 1 and hence the center of rotation has been shifted to a point designated by O′. In the above mentioned case, the traces of the magnetic head 9 deviate from the track of the radius R1 and from the track of the radius R2 respectively as designated by 40′ and 50′ and hence it is difficult to read out both the recorded patterns 40 (41 and 42) and 50 over the entire circumference. In the drawing, there is illustrated a state that the head 9 has been positioned on the track of the radius R2 by the piezoelectric stage 4, and the read signal from the eccentricity learning pattern 50 is detected only at points A and B (hereinafter, referred to as cross points) at which the trace 50′ of the head 9 intersects with the pattern 50. Reproduction waveforms (envelops) obtained at the points A and B are designated by 50A and 50B. The cross points are present at two positions (the points A and B) on the track and the position of each cross point is determined depending on the eccentric quantity.

Next, a rotational position (a phase angle) of each cross point is obtained. A time difference up to each cross point (the signal 50A or 50B) is calculated from a clock signal 31 (a clock number) using the index signal 30 as a reference to obtain a phase angle e measured from the index signal 30. In the above mentioned case, θA0 denotes the phase angle at the point A and θB0 denotes the phase angle at the point B.

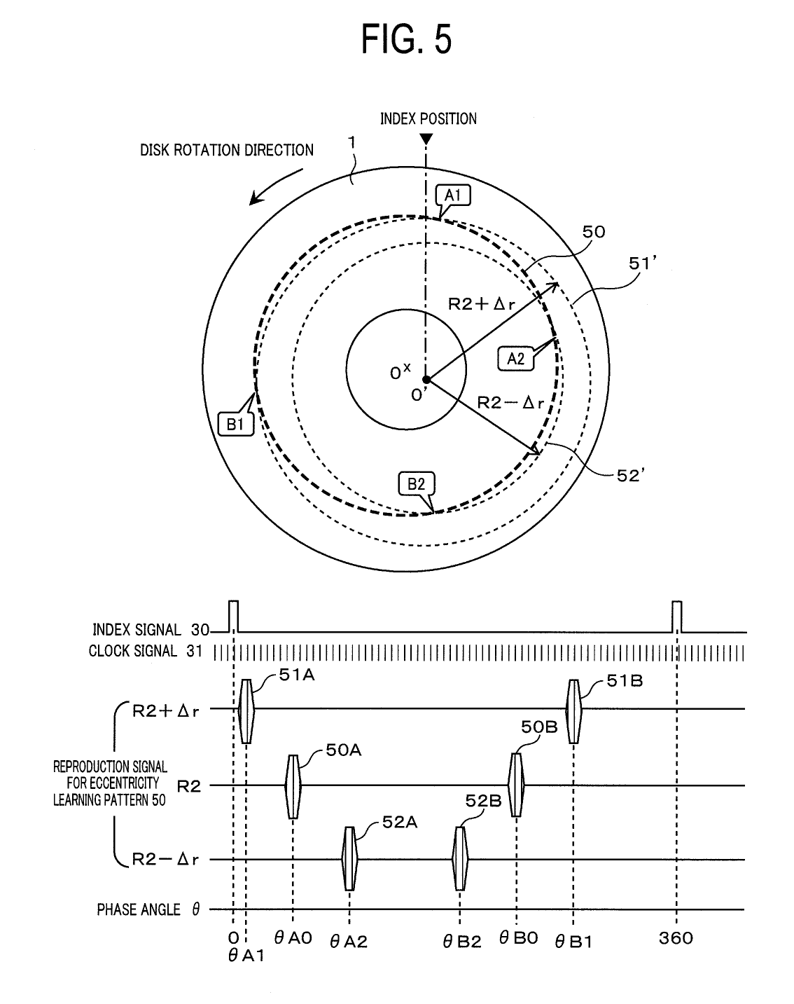

FIG. 5 is a diagram illustrating an example of changing of the cross point when a radial position for reading of the magnetic head 9 has been moved. The piezoelectric stage 4 is driven and a position where a signal is detected from the eccentricity learning pattern 50, that is, a cross point between the head trace and the eccentricity learning pattern 50 is obtained while moving the head 9 in the radius direction at a micro pitch. FIG. 5 illustrates reproduction signals obtained when the radial position for reading has been moved as designated by R2, R2+Δr and R2−Δr and relevant changing of the cross points. The head trace is as designated by 51′ and the cross points are as designated by A1 and B1 (reproduction signals 51A and 51B) at the position of the radius R2+Δr. The head trace is as designated by 52′ and the cross points are as designated by A2 and B2 (reproduction signals 52A and 52B) at the position of the radius R2−Δr. The phase angles at the above cross points are as designated by θA1, θB1, θA2 and θB2.

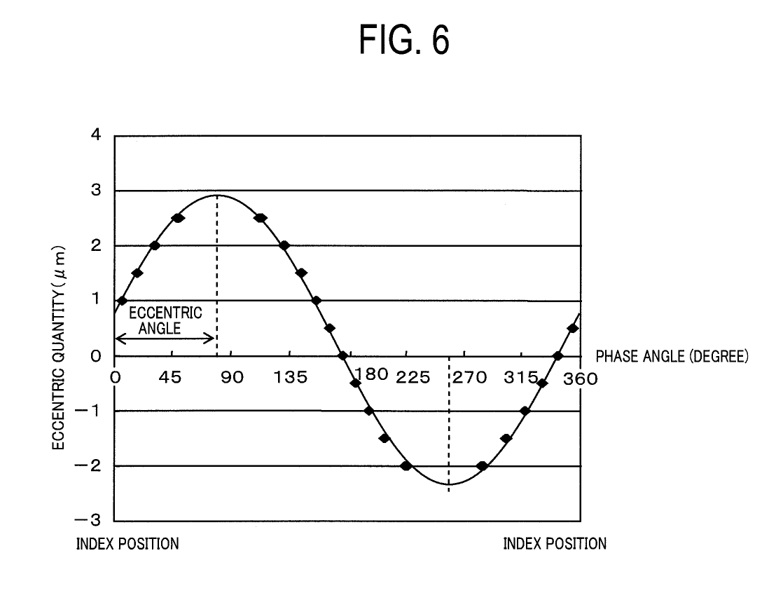

FIG. 6 is a diagram illustrating an example of a relation between the disc eccentric quantity and the phase angle obtained from measurement illustrated in FIG. 5. In FIG. 6, a movement value Δr of the radial position for reading of the head 9 is plotted on the vertical axis and the phase angle at the cross point obtained upon movement is plotted on the horizontal axis. Here, the movement value Δr of the head 9 is changed at a predetermined pitch (0.5 μm). Data on the plotted cross point is saved in the eccentricity learning data 22e in the memory 22. Then, when all pieces of desirable data (data on the predetermined movement values) are acquired, the saved data is read out to perform fitting approximation by a sine wave (SIN) curve. Use of a least squares method in fitting allows approximation which is more reduced in error occurrence. The SIN curve so obtained indicates the eccentric quantity in each rotational phase of the disk 1. Thus, learning of maximum eccentric quantity and eccentric direction (eccentric angle) of the disk 1 is allowed.

Incidentally, although it has been described in the example in FIG. 6 that approximation of the measured eccentric quantities is allowed by the SIN curve, approximation error may be increased in such a case that distortion occurs in roundness of the disk 1. In the case as mentioned above, it is allowed to reduce the approximation error by approximating the eccentric quantity by a polynomial including higher order components of the SIN function.

Next, the shaking control data 22f used for eccentricity correction is generated on the basis of the approximated SIN curve. The shaking control data 22f is generated by plotting rotational phases in tune with an interval between control timings and reading out a shaking amount (a voltage value) in each rotational phase from the approximated curve. In the above mentioned case, amplitudes and phases may be compensated for or an offset may be added by taking response characteristics of the piezoelectric actuator 7 which is a driving element into consideration. In this way, learning of the eccentric quantity is terminated.

After learning the eccentricity, the inspection test pattern 42 on the disk 1 is read out and inspected. The head 9 is moved onto the inspection track (the radius R1) and the servo pattern 41 is read out while operating the ON-track servo circuit 11 and the piezoelectric actuator 7. In the above mentioned situation, the shaking control data 22f stored in the memory 22 is supplied to the eccentricity cancelling shaking control circuit 14, the shaking control data 22f so supplied is added to a drive signal sent from the position control circuit 13 and then the piezoelectric actuator 7 is driven. As a result, the eccentricity of the disk 1 matches shaking of the head 9 to cancel the disk eccentricity, by which it is allowed to favorably control ON-track positioning.

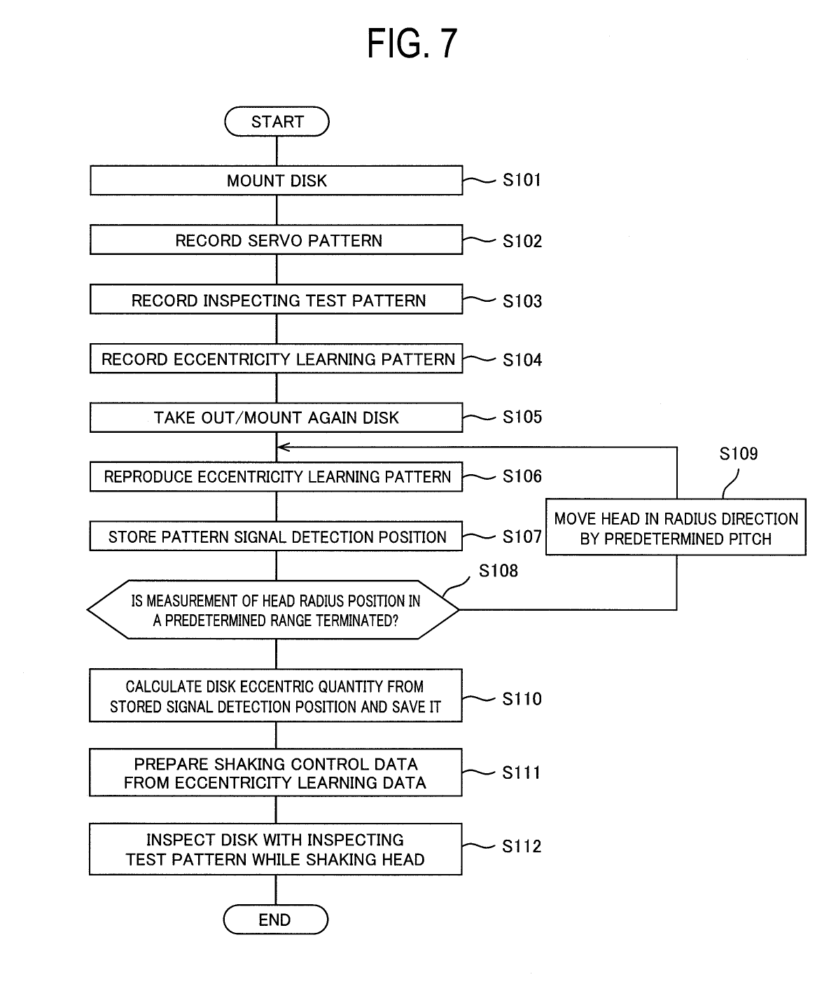

FIG. 7 is a flowchart illustrating an example of an inspection method performed by the magnetic read-write inspection apparatus according to the present embodiment.

In S101, a disk to be inspected is mounted and rotated. Incidentally, although it is supposed that this disk is an unused (unrecorded) one, when a signal is recorded on the disk, inspection is started after a surface on which the signal is recorded is once erased.

In S102, the servo patterns 41 are recorded one by one in arbitrary track ranges before and behind each track range for inspection test pattern on the inspection track of the predetermined radius R1 of the disk at the defined track pitch.

In S103, the magnetic head 9 is positioned on the inspection track of the radius R1 by the sector servo system to record the inspection test pattern 42 thereon. Incidentally, when the initial characteristics of the disk are to be inspected, it is sufficient to reproduce the inspection test pattern 42 which has been recorded following the above inspection.

In S104, positioning control performed by the sector servo system is set off and the head 9 is moved onto the position of the track of the radius R2 (different from the radius R1) of the disk to record the eccentricity learning pattern 50 thereon concentrically with the inspection test pattern 42.

In S105, the disk is taken out from the inspection apparatus, is again mounted on the apparatus and is rotated. Meanwhile, the disk is left in the constant temperature tank at the high temperature for the long period of time alone in order to inspect, for example, thermal demagnetization characteristics of the disk.

In S106, the magnetic head 9 is positioned on the track of the radius R2 of the disk or a position which is shifted from the track of the radius R2 by the amount Δr by the piezoelectric stage 4 and the eccentricity learning pattern 50 is reproduced without using the servo pattern for learning the eccentricity.

In S107, data on the position (the cross point between the head trace and the eccentricity learning track) where the signal of the eccentricity learning pattern 50 is detected is acquired from the reproduction signal and is stored in the memory (the eccentricity learning data 22e) together with the radial position for reading (the movement value Δr) of the head. Typically, two cross points are present and the rotational phase angles of the cross points are stored.

In S108, whether measurement of the radial position (the movement Δr) for reading of the head in a predetermined range has been terminated or not is determined. The predetermined range is determined in advance on the basis of an expected eccentric quantity of the disk. Alternatively, the measurement may be terminated when the cross points are not acquired at the radial position concerned. When the measurement is not yet terminated, the process proceeds to S109, while when it is terminated, the process proceeds to S110.

In S109, the head 9 is moved by the piezoelectric stage 4 by the predetermined pitch in the radius direction and the process returns to S106. Then, the eccentricity learning pattern 50 is reproduced to acquire the cross points again.

In S110, when all pieces of desirable data are acquired, the data on the signal detection positions (the cross points) stored in the memory is read out, fitting approximation is performed by the sine wave (SIN) curve to calculate the eccentric quantity of the disk and the calculated electric quantity is saved.

In S111, the shaking control data 22f indicating the head shaking amount corresponding to each rotational phase is prepared from the learned eccentric quantity of the disk and saved. The shaking control data 22f is used to cancel the eccentric quantity of the disk.

In S112, the head 9 is moved onto the inspection track of the radius R1 and inspects the disk by reading out the inspection test pattern 42. In the above mentioned case, the ON-track servo circuit 11 and the piezoelectric actuator 7 are operated to correct the eccentric quantity of the disk by adding the shaking control data 22f thereto.

According to the present embodiments, since it is allowed to correct the eccentric quantity generated when the magnetic disk is mounted again by learning the eccentricity, highly accurate and highly efficient inspection is allowed by applying the sector servo system as described in the foregoing.

While we have shown several embodiments in accordance with out invention, it should be understood that disclosed embodiments are susceptible of changes and modifications without departing from the scope of the invention. Therefore, we do not intend to be bound by the details shown herein but intend to cover all such changes and modifications that fall within the ambit of the appended claims.

What is claimed is:

1. A magnetic read-write inspection apparatus for writing a test signal together with servo information onto a magnetic disk by a magnetic head and reading out the written test signal by the magnetic head, comprising:
a data write unit which writes the servo information and the test signal onto a predetermined inspection track of the magnetic disk and concentrically writes an eccentricity learning pattern onto an eccentricity learning track which is different from the inspection track using the magnetic head;
a data read unit which reads out the test signal from the inspection track of the magnetic disk in accordance with the servo information and reads out the eccentricity learning pattern from the eccentricity learning track using the magnetic head;
an eccentric quantity learning unit which calculates an eccentric quantity of the magnetic disk from a detection position of a read signal by reading out the eccentricity learning pattern without using the servo information; and
an eccentric quantity correction unit which controls shaking of the magnetic head so as to cancel the calculated eccentric quantity when reading out the test signal from the magnetic disk.

2. The magnetic read-write inspection apparatus according to claim 1, wherein
the eccentric quantity learning unit reads out the eccentricity learning pattern while moving the magnetic head in a radius direction of the disk using a radius position of the eccentricity learning track as a reference and calculates the eccentric quantity of the magnetic disk from a relation between a value of movement and the detection position of the read signal.

3. The magnetic read-write inspection apparatus according to claim 1, further comprising:
as elements driving the magnetic head in the radius direction of the magnetic disk,
a piezoelectric stage adapted to position the magnetic head when writing/reading out the eccentricity learning pattern onto/from the magnetic disk; and
a piezoelectric actuator which shakes the magnetic head in order to cancel the eccentric quantity of the magnetic disk.

4. A magnetic read-write inspection method of writing a test signal together with servo information onto a magnetic disk by a magnetic head and reading out the written test signal by the magnetic head, comprising the steps of:
writing the servo information and the test signal onto a predetermined inspection track of the magnetic disk using the magnetic head;
concentrically writing an eccentricity learning pattern onto an eccentricity learning track which is different from the inspection track using the magnetic head;
reading out the eccentricity learning pattern without using the servo information from the eccentricity learning track of the magnetic disk using the magnetic head;
calculating an eccentric quantity of the magnetic disk from a detection position of a read signal for the eccentricity learning pattern; and
reading out the test signal from the inspection track of the magnetic disk in accordance with the servo information while controlling shaking of the magnetic head so as to cancel the calculated eccentric quantity.

5. The magnetic read-write inspection method according to claim 4, wherein
in the step of calculating the eccentric quantity, the eccentricity learning pattern is read out while moving the magnetic head in the radius direction of the magnetic disk using a radius position of the eccentricity learning track as a reference and the eccentric quantity of the magnetic disk is calculated from a relation between a value of movement and the detection position of the read signal.
